(19) United States
(12) Patent Application Publication
(10) Pub. No.: US 2017/0314769 A1
(43) Pub. Date: Nov. 2, 2017

(54) CLAMP AND CLAMP WITH LIGHT

(71) Applicant: Walter R. Tucker Enterprises, Ltd. D/B/A E-Z Red Company, Deposit, NY (US)

(72) Inventor: Robert CACCIABEVE, Boonton, NJ (US)

(73) Assignee: Walter R. Tucker Enterprises, Ltd. D/B/A E-Z Red Company, Deposit, NY (US)

(21) Appl. No.: 15/200,899

(22) Filed: Jul. 1, 2016

Related U.S. Application Data
(63) Continuation of application No. 29/562,748, filed on Apr. 28, 2016, now Pat. No. D795684.
Application No. 29/562,748 is a continuation of application No. 29/562,752, filed on Apr. 28, 2016, now Pat. No. D786660.

(51) Int. Cl. F21V 21/088; F21V 19/02; F16B 2/10

(52) U.S. Cl. CPC F21V 21/0885; F16B 2/10; F21V 19/02

(57) ABSTRACT

A clamp and a clamp with light are disclosed for attachment to a work area such as a vehicle hood. The clamp with light includes a clamp having an upper arm with one or more bumpers, a lower arm with one or more bumpers connected to the upper arm, a rotating arm for vertical movement of the light, and a light connected to the clamp.

### RELATED APPLICATIONS

This application is a continuation of U.S. application Ser. No. 29/562,748, filed Apr. 28, 2016, entitled “Clamp,” and U.S. application Ser. No. 29/562,752, filed Apr. 28, 2016, entitled “Clamp With Light,” and claims benefit of these applications under 35 U.S.C. §120, which applications are incorporated herein by reference in their entirety.

### FIELD OF THE INVENTION

The invention relates to a clamp and a clamp with a light. More particularly, the invention relates to a clamp and clamp with a light used as an under hood clamp for vehicles or the like.

### BACKGROUND OF THE INVENTION

Vehicles are often repaired in service stations, garages, or body shops. When working on the engine of a vehicle or underneath the vehicle, light is required by the worker. For example, trouble lights have been used for many years whereby the light is hung from an aperture underneath the hood of the vehicle to place light on the vehicle engine. Other under hood work lights are known which are elongated and attach at each end of a hood of a vehicle. While these devices are sometimes adequate to provide light to the work area, the devices have various shortcomings including that they do not direct light to a specific area of use; the devices may be complex and expensive; the devices may be difficult to use because of their size and shape, e.g. they are bulky, heavy and not easily transportable; and/or the devices are time consuming and expensive to manufacture. These and other shortcomings of the known devices are addressed by the present invention.

### SUMMARY OF THE INVENTION

A primary object of the invention is to provide a clamp for attachment to an object and which may receive a light.

Another primary object of the invention is to provide a clamp with a light.

Another primary object of the invention is to provide a clamp with a light which clamp is easily attached to a work area such as a vehicle.

Another primary object of the invention is to provide a clamp with a light for attachment to the hood of the vehicle to focus the light on a work area.

Another primary object of the invention is to provide a clamp with a light which allows the light to move vertically about the clamp to focus the light on the work areas.

Another primary object of the invention is to provide a clamp with a light which provides hands free lighting and allows for the clamp to be attached to various parts of a vehicle to direct light to appropriate work areas.

The clamp invention comprises an upper arm with one or more bumpers, a lower arm with one or more bumpers, a connector for connecting the upper arm and the lower arm, a spring for providing clamping pressure, a rotating arm for vertical movement of a light, and an attachment member for attaching a light.

The invention is further directed to a clamp and a light comprising an upper arm with one or more bumpers, a lower arm with one or more bumpers, a connector for connecting the upper arm and lower arm, a spring for providing clamping pressure, a rotating arm for vertical movement of a light, an attachment member for attaching a light and a light.

The invention may further include a ratchet for providing the vertical movement to the rotating arm.

The invention may further include a twist assembly to allow horizontal rotation of a light attached to the clamp.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 is a front/side elevational perspective view of the clamp with light.

FIG. 2 is a first side view of the clamp with light.

FIG. 3 is a second side view of the clamp with light.

FIG. 4 is a rear view of the clamp with light.

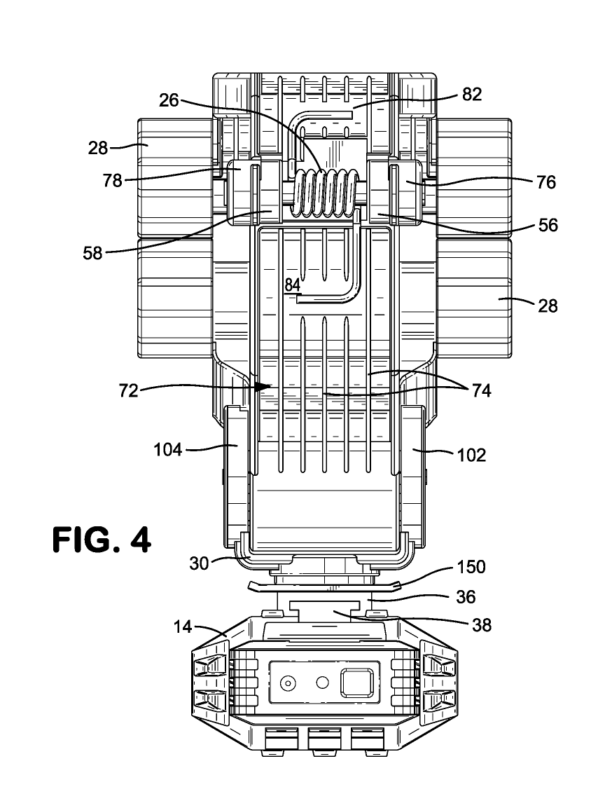

FIG. 5 is a front view of the clamp with light.

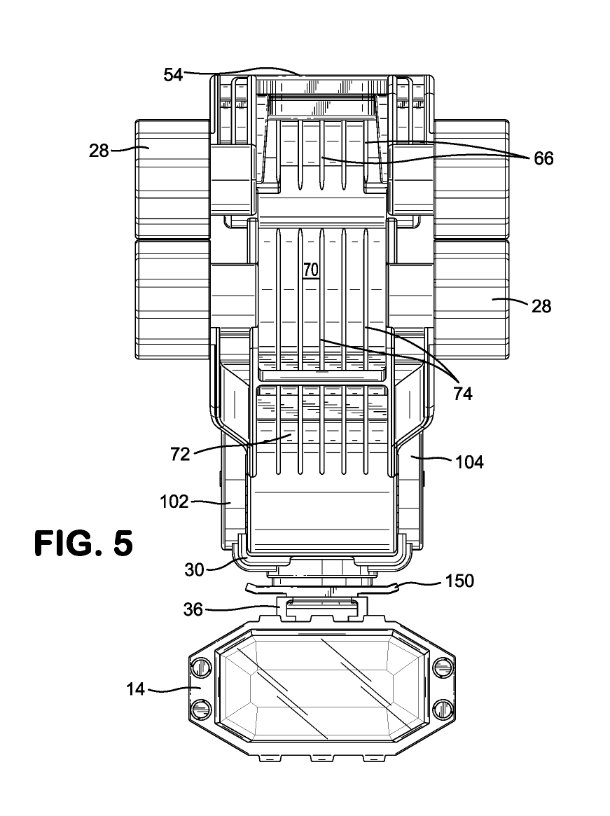

FIG. 6 is a bottom view of the clamp with light.

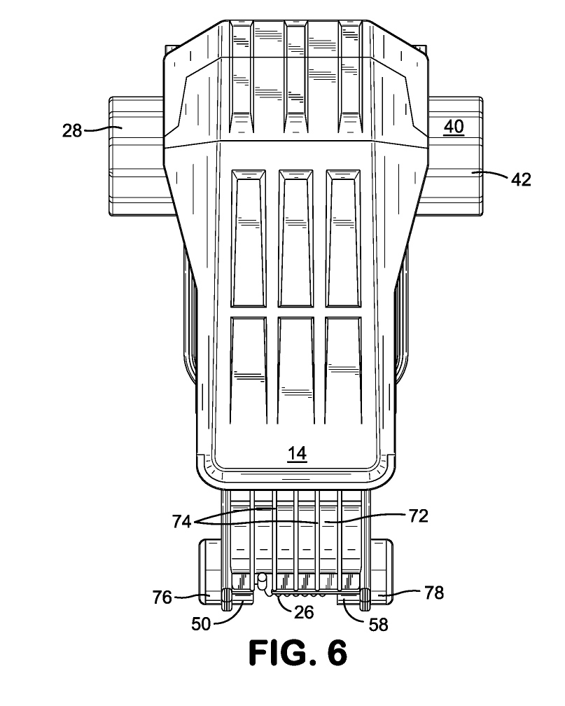

FIG. 7 is a top view of the clamp with light.

FIG. 8 is an exploded view of the clamp.

FIG. 8A is a partial side view of the clamp with light of FIG. 2 without the rotating arm and the light and with the cover for the ratchet removed to show the ratchet housing and a bumper removed to show the bumper connector.

FIG. 8B is a top view of the rotating arm.

FIG. 8C is an enlarged view of parts of the twist assembly and illustrates a clip to hold a light.

FIG. 9 is a side view of the clamp with light of FIGS. 1 and 2 showing the clamp in an open position to be attached to a work area.

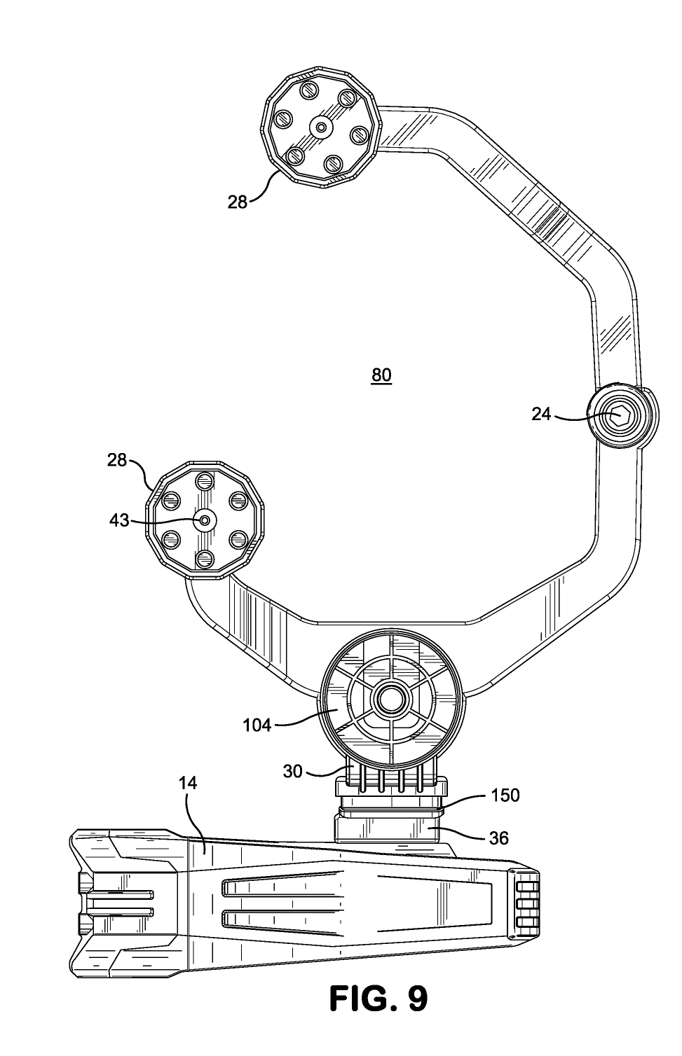

FIG. 10 illustrates the clamp with light of FIG. 1 in an environment of use.

### DETAILED DESCRIPTION OF THE PREFERRED EMBODIMENTS

The present invention is directed to a clamp and a clamp with a light. The invention may be used for clamping the clamp to a vehicle to provide a light source, for example, under the hood of the vehicle to allow a worker to work on the engine. The clamp may also be attached to other vehicle parts such as fender wells, trunk lids, hatch lids or the like. Additionally, the clamp and light may be used in other environments requiring a light source.

The clamp and light invention provides for hands free lighting and allows for directing the light to a specific work area. The light may be a rechargeable light or a corded light. The light is preferably removably attached to the clamp.

The invention is directed to a clamp and light 10 having a clamp 12 and light 14. The clamp 12 comprises an upper arm 20 and lower arm 22 connected by a connector 24. The clamp includes a spring 26 for opening and closing the clamp and providing downward clamping pressure on the work piece to which the clamp is attached. The clamp arms 20 and 22 include bumpers 28. Attached to lower arm 22 is a rotating arm 30 for allowing vertical rotation of a light 14 about clamp 12. Rotating arm 30 rotates through a ratchet 32. The light may also rotate horizontally about the clamp by a twist assembly 34. The clamp includes a clip mount 36 for attachment of light 14 by a T-shaped clip 38. These primary components of the clamp and light 10 will be discussed in further detail below.

Referring to the Figures, the clamp 12 includes upper arm 20 and lower arm 22. Each of these arms includes a bumper 28. Bumper 28 is preferably made of a soft material such as rubber and will clamp to the work area, e.g. a hood of a vehicle, and protect the surface such as a painted hood of a vehicle. The bumpers 28 may include flat surfaces 40 and ridges 42, although the bumpers may be otherwise configured without departing from the scope of the invention, e.g. a round bumper. The bumpers are attached to the ends of the clamp arms 20 and 22 by fastening members 43, such as a screw. The bumpers 28 attach to a corresponding bumper connector 44 having corresponding flat surfaces 40a and ridges 42a. The bumper connector includes a fastener aperture 43a for receiving the fastener 43. Bumper connector 44 further includes grooves 46 to which support arms 48 are connected to provide rigidity and strength to the bumper connector 44 and the bumper 28. In a preferred embodiment, upper arm 20 and lower arm 22 include two bumpers 28. However, it is understood that a different number of bumpers may be used without departing from the scope of the invention, e.g. one elongated bumper from upper arm 20 and one elongated bumper for lower arm 22 or variations thereof.

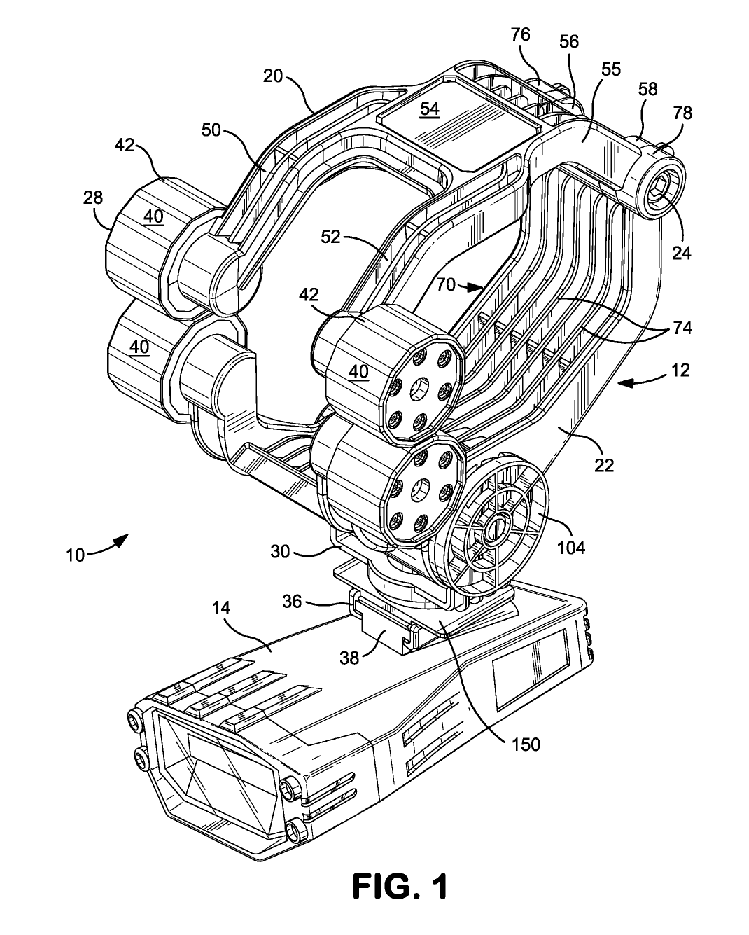

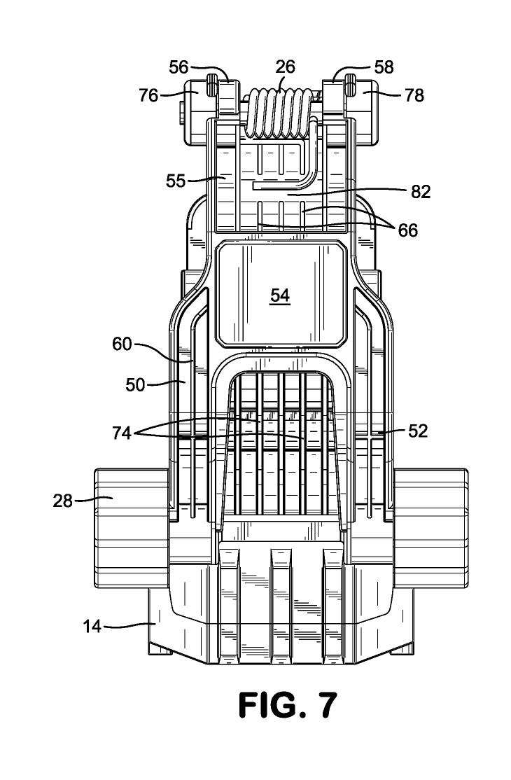

The upper arm 20 viewed from the top, e.g. FIGS. 1 and 7, includes a generally Y-shaped configuration comprising legs 50 and 52, a generally flat connection portion 54 and leg 55 which extends downwardly toward connector apertures 56 and 58. Upper arm 22 includes a plurality of ribs 60 for both aesthetics and to provide rigidity, strength and a light weight clamp.

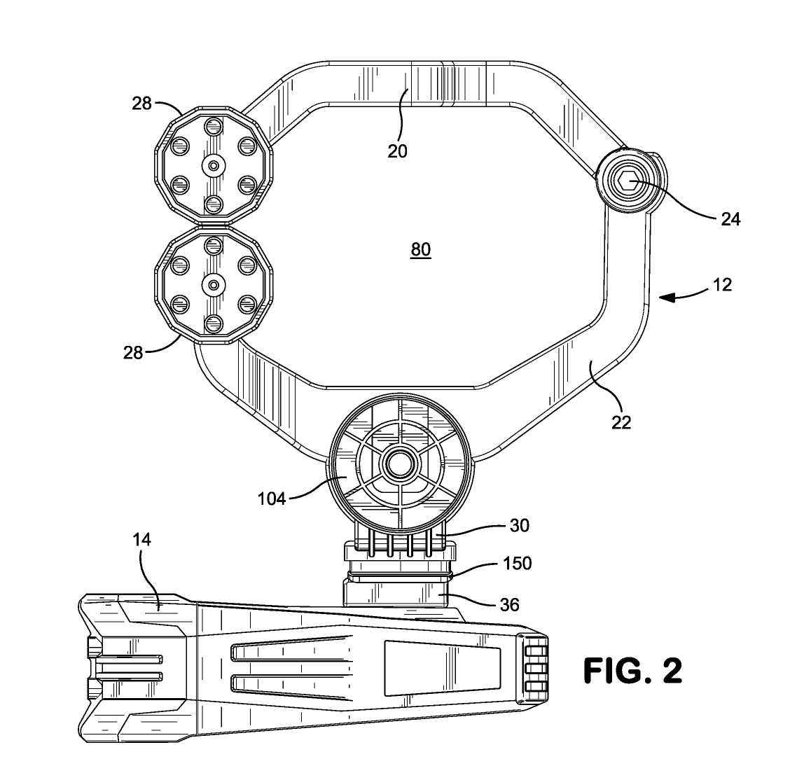

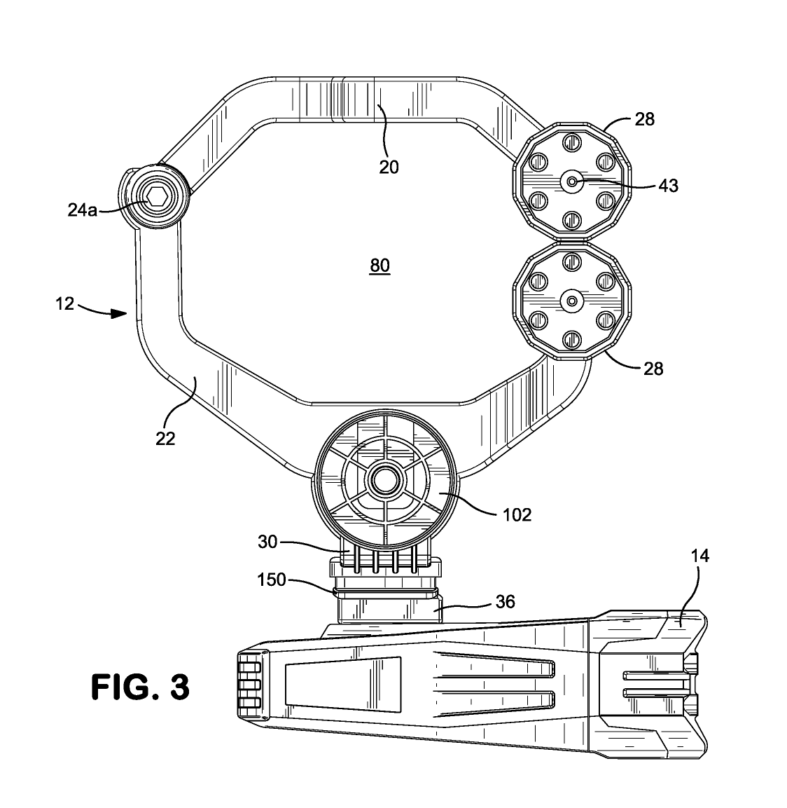

Lower arm 22 is generally U-shaped when viewed from the side, e.g. FIGS. 2 and 3. Lower arm 22 comprises an inner surface 70 and an outer surface 72, both including ribs 74 for both aesthetics and to provide rigidity, strength and a light weight clamp. The lower arm includes connector apertures 76 and 78 for receiving a connector 24 as discussed below. Lower arm 22 further includes a rotating arm 30 and ratchet 32 as also discussed below. Lower arm 22 and upper arm 20 generally provide for an O-shaped open area 80 to provide a sufficiently large area for attaching the clamp 12 to a work area such as a vehicle hood.

Upper arm 20 and lower arm 22 are connected by a connector 24, preferably a bolt 24 and nut 24a, extending through aligned upper arm 20 and lower arm 22 connector apertures 56, 58, 76 and 78. Additionally, a spring 26 is provided to provide the tension for operation of the clamp. Bolt 24 extends though spring 26, and spring 26 seats through tension at area 82 of upper arm 20 and at area 84 of lower arm 22.

Lower arm 22 includes a rotating arm 30 and ratchet 32 which allows for the rotation of arm 30 to provide vertical movement of the light 14 to different positions, e.g. six positions, to allow the light source to be focused on a specific work area. Rotating arm 30 is connected to ratchet 32 by a bolt 90 and nut 92. The rotating arm 30 works in conjunction with ratchet 32 to provide vertical movement to light 14 and will now be described in further detail.

The rotating arm 30 includes a base 100 and ears 102 and 104 which cover the ratchet 32. Rotating arm 30 further includes an annular opening 106 in base 100 having on the inside thereof a plurality of grooves 108 for the horizontal rotational movement of light 14 as discussed below. Rotating arm 30 include a channel 110 in ear 104.

Ratchet 32 includes a housing 120 having therein a shaft 122 having ribs 124 for receiving bolt 90 connecting rotating arm 30 to ratchet 32. The housing includes a vertical annular wall 126, apertures 128 for receiving fasteners 130; and a hexagonal shaft 132 for receiving a spring 134 around shaft 122 and ribs 124. The housing 120 is closed by cover 136 using fasteners 130. Ratchet 32 includes bottom ratchet teeth 138 which mate with top ratchet teeth 140. Bottom ratchet teeth 138 include a hexagonal base 142 which fits in hexagonal shaft 132 and top ratchet teeth 140 includes a nut configuration 144 which extends through the opening 146 of cover 136 and fits in channel 110 of rotating arm 30, thereby providing the ratcheting positional movement by rotating arm 30 and ratchet 32 through movement of ratchet top and bottom teeth 138 and 140.

The light 14 will also rotate in a horizontal plane based on a twist assembly 34. Twist assembly 34 functions in conjunction with parts of clip mount 36; the assembly including a clip lock mounting plate 150 having opening 151, the clip mount 36 having a ring 152 adapted to fit through opening 151 of clip lock mounting plate 150 into opening 106 of rotating arm 30. The ring 152 includes a slot 154 for receiving a spring 156 and indexing member 158 which extends out the end of slot 154 and engages grooves 108 of rotating arm 30, thereby providing for a plurality of horizontal rotational positions for light 14. There is a connector plate 160 for connecting the twist assembly 34 having apertures 162 for receiving fasteners 164 to engage corresponding aperture 166 of ring 152.

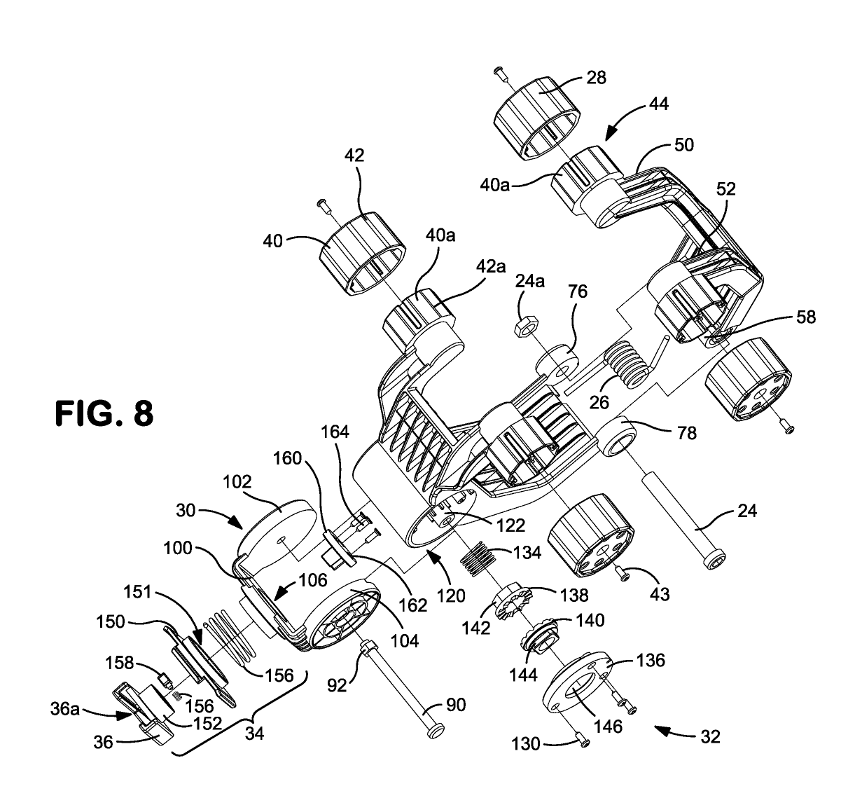

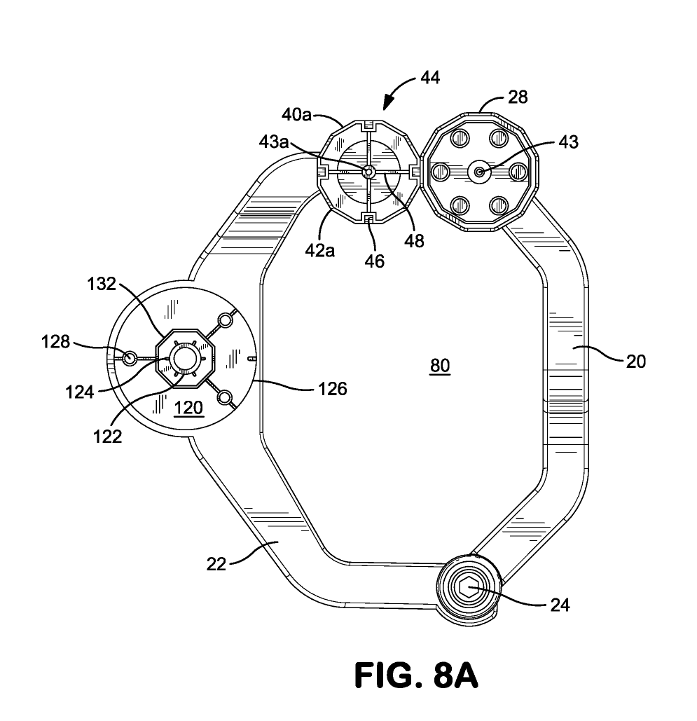

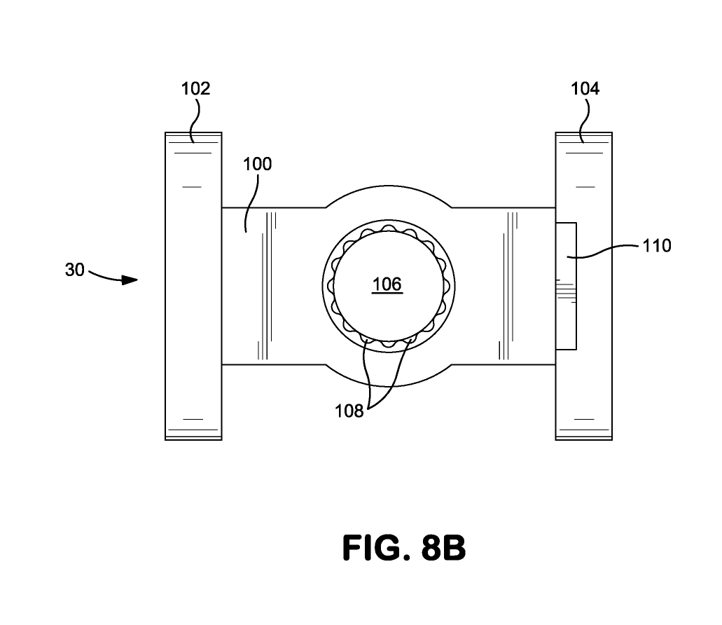

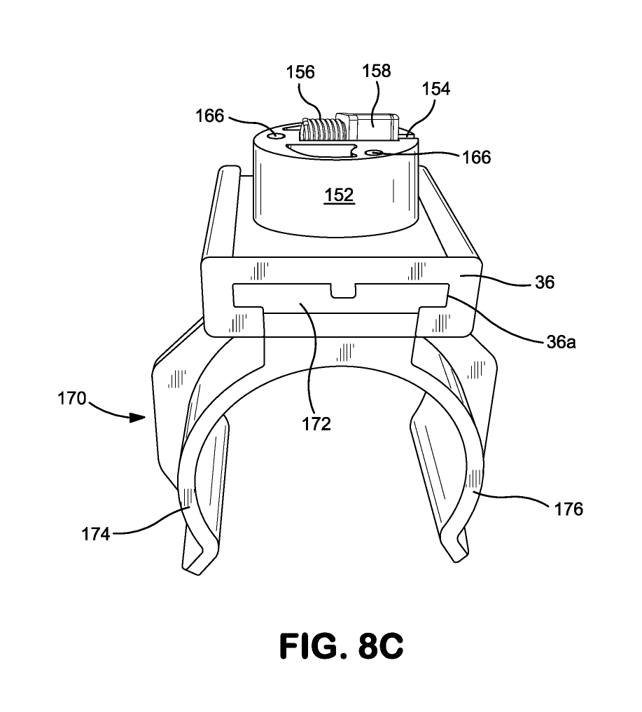

As noted above, light 14 includes a T-shaped clip 38 which fits into slot 36a of clip mount 36 to attach light 14 to clamp 112. In the alternative, referring to FIG. 8C, a clip 170 may fit in slot 36a of clip mount 36 for holding light 14. Clip 170 includes T-shaped mount 172 having legs 174 and 176 for receiving a mounting member of a light.

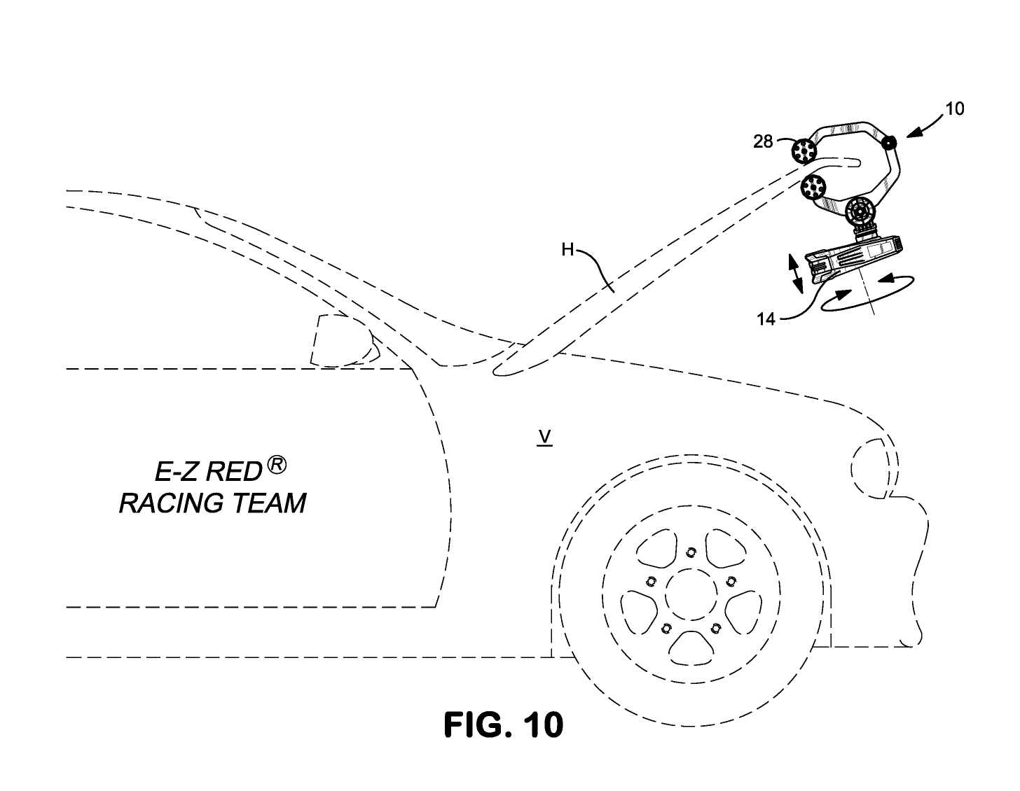

Referring to FIG. 10, the clamp and light 10 is shown attached to the hood H of a vehicle V. The light 14 may be rotated by rotating arm 30 in conjunction with ratchet 32 to provide vertical movement of the light to direct the light source to specific work areas. Additionally, the light 14 may rotate in a horizontal plane based on twist assembly 34.

The clamp and light of the invention provide for an easy to use under hood light capable of directing the light source to specific areas of use. The clamp and light are compact and easy to handle and use. Bumpers 28 provide for a secure clamping connection of the clamp 12 to the work area and will not damage the work area. The clamp 12 is preferably made of plastic and is durable and light in weight, thereby making it easy to use and move about in workshops or other environments of use. However, the clamp may be made of other materials such as metal without departing from the scope of the invention.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A clamp comprising:
an upper arm having at least one bumper,
a lower arm having at least one bumper connected to said upper arm,
a spring connected to said upper arm and said lower arm and adapted to provide clamping pressure,
a rotating arm connected to said lower arm and adapted to receive a light and adapted to provide vertical movement of said light.

2. A clamp according to claim 1 further comprising a light connected to said clamp.

3. A clamp according to claim 2 wherein said upper arm includes two bumpers and said lower arm includes two bumpers.

4. A clamp according to claim 3 further comprising a ratchet connected to said rotating arm and adapted to provide ratcheting vertical movement of said light on said clamp.

5. A clamp according to claim 3 further comprising a twist member connected to said rotating arm adapted to provide horizontal rotational movement to said light.

6. A clamp comprising:
an upper arm having two bumpers,
a lower arm having two bumpers connected to said upper arm,
a spring connected to said upper arm and said lower arm and adapted to provide clamping pressure,
a rotating arm connected to said lower arm and adapted to receive a light and adapted to provide vertical movement of said light,
a ratchet connected to said rotating arm and adapted to provide ratcheting vertical movement to said light on said clamp in conjunction with said rotating arm,
a twist assembly connected to said rotating arm and adapted to provide horizontal rotational movement to said light, and
a light connected to said clamp.
